(19) United States
(12) Patent Application Publication
(10) Pub. No.: US 2024/0371192 A1
(43) Pub. Date: Nov. 7, 2024

(54) SYSTEMS AND METHODS FOR PERSON DETECTION AND CLASSIFICATION

(71) Applicant: Sensormatic Electronics, LLC, Boca Raton, FL (US)

(72) Inventors: Karthik JAYARAMAN, Coimbatore (IN); Gopi Subramanian, Delray Beach, FL (US)

(21) Appl. No.: 18/311,551

(22) Filed: May 3, 2023

(51) Int. Cl. G06V 40/10; G06V 10/40; G06V 10/74; G06V 20/52; G08B 13/196

(52) U.S. Cl. CPC G06V 40/10; G06V 10/40; G06V 10/74; G06V 20/52; G08B 13/196

(57) ABSTRACT

Example implementations include a method, apparatus and computer-readable medium for person detection in a security system, comprising receiving a video stream captured by a camera installed in an environment. The implementations further include identifying a first person in one or more images of the video stream. Additionally, the implementations further include extracting a plurality of visual attributes of the first person that do not include personal identifiable information from the one or more images, wherein the personal identifiable information is a data point unique to the first person that can identify the first person without any other data points. Additionally, the implementations further include encoding the plurality of visual attributes into a first signature representing the first person. Additionally, the implementations further include generating a security alert in response to the first signature corresponding to a second signature of a second person tagged as a security risk.

### TECHNICAL FIELD

The described aspects relate to security systems.

### BACKGROUND

Aspects of the present disclosure relate generally to security systems, and more particularly, to security systems featuring person detection and classification.

Individuals that engage in theft, vandalism, and other illegal actions may be referred to as red shoppers. In order to prevent red shoppers from performing malicious actions, retailers often hire extra security to patrol and/or monitor the retail environment. In some cases, retailers install security cameras for additional monitoring.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method for person detection in a security system, comprising receiving a video stream captured by a camera installed in an environment. The method further includes identifying a first person in one or more images of the video stream. Additionally, the method further includes extracting a plurality of visual attributes of the first person that do not include personal identifiable information from the one or more images, wherein the personal identifiable information is a data point unique to the first person that can identify the first person without any other data points. Additionally, the method further includes encoding the plurality of visual attributes into a first signature representing the first person. Additionally, the method further includes comparing the first signature with a plurality of signatures of persons tagged as security risks. Additionally, the method further includes generating a security alert in response to the first signature corresponding to a second signature of the plurality of signatures based on comparing the first signature with the plurality of signatures of persons tagged as security risks.

Another example aspect includes an apparatus for person detection in a security system, comprising a memory and a processor coupled with the memory. The processor is configured to receive a video stream captured by a camera installed in an environment. The processor is further configured to identify a first person in one or more images of the video stream. Additionally, the processor further configured to extract a plurality of visual attributes of the first person that do not include personal identifiable information from the one or more images, wherein the personal identifiable information is a data point unique to the first person that can identify the first person without any other data points. Additionally, the processor further configured to encode the plurality of visual attributes into a first signature representing the first person. Additionally, the processor further configured to compare the first signature with a plurality of signatures of persons tagged as security risks. Additionally, the processor further configured to generate a security alert in response to the first signature corresponding to a second signature of the plurality of signatures based on comparing the first signature with the plurality of signatures of persons tagged as security risks.

Another example aspect includes an apparatus for person detection in a security system, comprising means for receiving a video stream captured by a camera installed in an environment. The apparatus further includes means for identifying a first person in one or more images of the video stream. Additionally, the apparatus further includes means for extracting a plurality of visual attributes of the first person that do not include personal identifiable information from the one or more images, wherein the personal identifiable information is a data point unique to the first person that can identify the first person without any other data points. Additionally, the apparatus further includes means for encoding the plurality of visual attributes into a first signature representing the first person. Additionally, the apparatus further includes means for comparing the first signature with a plurality of signatures of persons tagged as security risks. Additionally, the apparatus further includes means for generating a security alert in response to the first signature corresponding to a second signature of the plurality of signatures based on comparing the first signature with the plurality of signatures of persons tagged as security risks.

Another example aspect includes a computer-readable medium having instructions stored thereon for person detection in a security system, wherein the instructions are executable by a processor to receive a video stream captured by a camera installed in an environment. The instructions are further executable to identify a first person in one or more images of the video stream. Additionally, the instructions are further executable to extract a plurality of visual attributes of the first person that do not include personal identifiable information from the one or more images, wherein the personal identifiable information is a data point unique to the first person that can identify the first person without any other data points. Additionally, the instructions are further executable to encode the plurality of visual attributes into a first signature representing the first person. Additionally, the instructions are further executable to compare the first signature with a plurality of signatures of persons tagged as security risks. Additionally, the instructions are further executable to generate a security alert in response to the first signature corresponding to a second signature of the plurality of signatures based on comparing the first signature with the plurality of signatures of persons tagged as security risks.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram of signature generation, in accordance with exemplary aspects of the present disclosure.

FIG. 2 is a block diagram of class generation, in accordance with exemplary aspects of the present disclosure.

FIG. 3 is a block diagram of performing actions based on a detected class of a person, in accordance with exemplary aspects of the present disclosure.

FIG. 4 is a block diagram of an example of a computer device having components configured to perform a method for person detection in a security system;

FIG. 5 is a flowchart of an example of a method for person detection in a security system;

FIG. 6 is a flowchart of additional aspects of the method of FIG. 5;

FIG. 7 is a flowchart of additional aspects of the method of FIG. 5;

FIG. 8 is a flowchart of additional aspects of the method of FIG. 5;

FIG. 9 is a flowchart of additional aspects of the method of FIG. 5; and

FIG. 10 is a flowchart of additional aspects of the method of FIG. 5.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The present disclosure includes apparatuses and methods that provide person classification and detection using non-confidential and/or non-private information. When capturing security footage of an environment, certain conventional security systems alert users of events. These events may range from the detection of motion in a scene to the detection of a specific individual. For example, a conventional security system may utilize facial recognition to identify known suspicious shoppers in a retail environment. However, there are at least two downsides of such conventional security systems. First, a facial recognition system may need additional special cameras that can better capture faces. Acquiring and installing such cameras may be costly or time consuming for users. Second, training a facial recognition algorithm involves saving a plurality of labelled facial images. A facial image is personal identifiable information (PII). PII is any information that, when used alone, can identify an individual. Other examples of PII include biometrics (e.g., fingerprints), government issued identifiers such as a social security number or a passport number, medical records, financial information such as a bank account number, etc. Training datasets that include PII pose privacy issues because they are vulnerable to data breaches and cyberattacks. Because of this, regulatory bodies often prohibit the collection and storage of PII for classification systems.

Although PII is useful in detecting individuals, and in particular identifying red shoppers, PII cannot always be relied upon. For example, storage of PII in certain European countries is not allowed. This makes security systems trained using PII ineffective and potentially illegal in such countries.

The systems and methods of the present disclosure identify persons entering an environment as a red shopper without using PII, which provides the benefit of privacy. The systems and methods are also applicable to normal camera feeds, so the requirement for edge hardware is less costly and demanding compared to facial recognition systems.

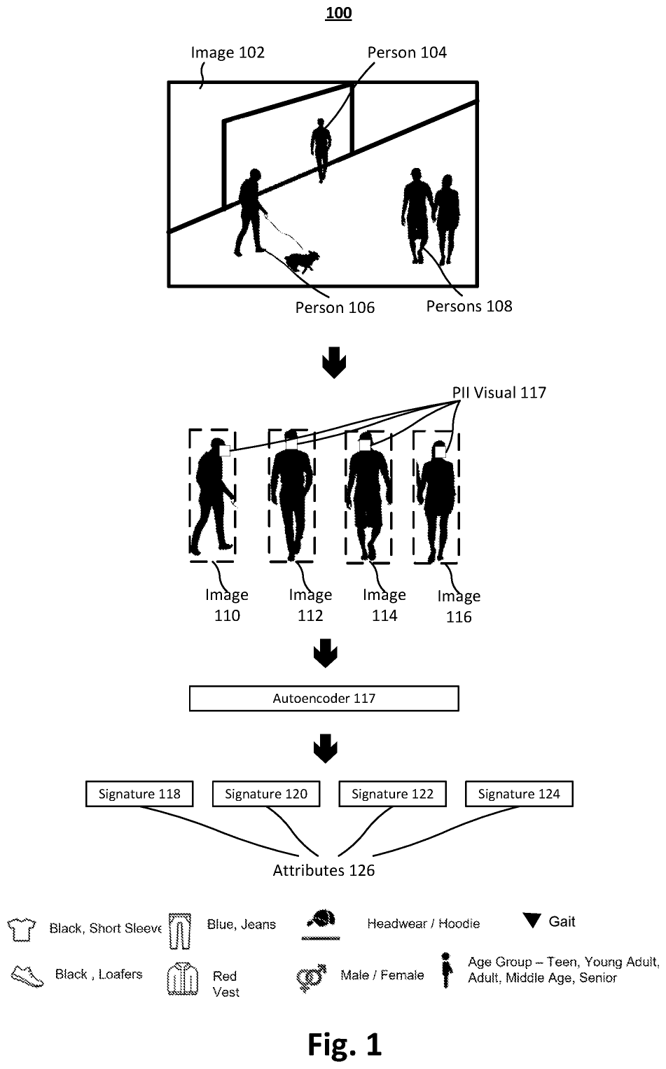

FIG. 1 is diagram 100 of signature generation based on non-PII information for use in subsequent person detection in a security system, in accordance with exemplary aspects of the present disclosure. Diagram 100 includes an image 102, which may be a frame from a video stream captured by a camera installed in an environment. For example, the environment may be retail store and the camera may face the main entrance of the retail store. Image 102 captures persons 104, 106, and 108 walking in the environment. Suppose that person 104 is a red shopper (i.e., an individual tagged as a security risk by the user (e.g., security personnel)). For example, person 104 may have performed a theft in the past and is potentially looking to steal again. Without using PII, the systems and methods of the present disclosure classify person 104 as a red shopper and can generate notices to alert store personnel.

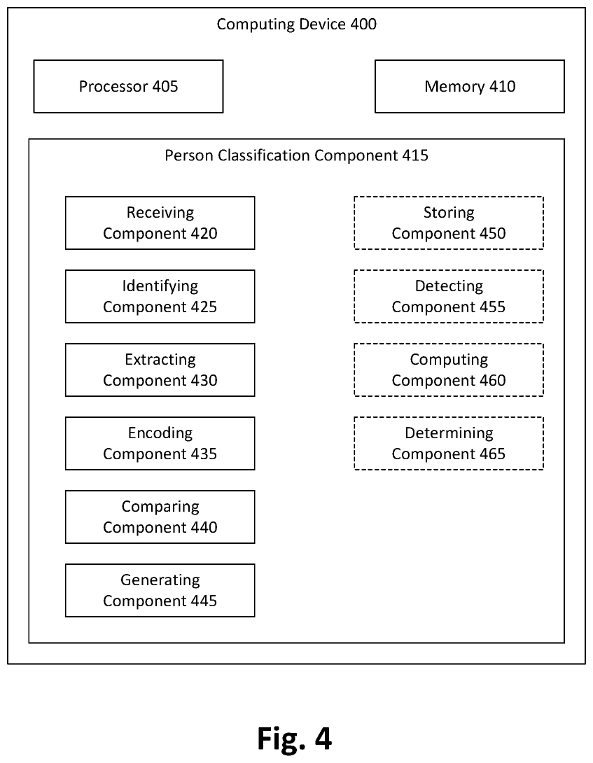

In particular, a person classification component may be executed to classify person 104. Person classification component 415 (see FIG. 4) may receive a video stream and extract images of the persons in each video frame (e.g., image 102) using a machine learning algorithm that identifies persons in an image.

For example, person classification component 415 may extract image 110 of person 106, image 112 of person 104, and images 114 and 116 of persons 108. Each of these images include various visual attributes of the respective person, including PII visuals 117 (e.g., facial images).

In some aspects, person classification component 415 filters the images by actively scanning images 110, 112. 114, and 116 and omitting PII-related visuals. For example, person classification component 415 may crop/blur/black out the facial features in the respective images. Other PII visuals that person classification component 415 may remove from images 110, 112, 114, and 116 include, but are not limited to, fingerprints (e.g., if a close up of a hand is detected) and identification cards (e.g., name tags). In some aspects, the person classification component 415 may execute a machine learning algorithm and/or model that solely classifies the presence of PII visuals (e.g., the presence of a face or fingerprint) in an input image and removes the visual from the input image. The person classification component 415 may then input filtered images 110, 112, 114. and 116 into autoencoder 117 that generates signatures 118, 120, 122, and 124, respectively. In some aspects, autoencoder 117 is a pre-trained model trained on a dataset including thousands of random person images. If autoencoder 117 receives two images of the same person, the signatures of those images will be very close to each other. For example, the vector representation of the two images will have a distance less than a threshold distance. This is explained further below. In some aspects, autoencoder 117 is a neural network that learns an efficient data representation of the input filtered images and ultimately generates a respective output vector that represents cach input image.

In other aspects, person classification component 415 does not actively filter out PII visuals in the extracted images from image 102, but performs a visual attribute collection function that does not collect attributes associated with PII from the extracted images. In some aspects, cach signature may represent a plurality of visual attributes including, but not limited to, attire information (e.g., colors, patterns, and sizes of tops, bottoms, hoodies, shoes, headwear, outerwear), gender (e.g., male, female, etc.), ethnicity, age group, and gait analysis. Each of these visual attributes may be extracted from an image (e.g., image 110) by a machine learning algorithm trained to identify a particular visual attribute. For example, a first machine learning algorithm may receive an image and output attire information if the person (e.g., black tee shirt, black loafers, blue jeans, red vest, black hat). A second machine learning algorithm may be receive an image and output a gender, age, and/or ethnicity of the person in the image. A third machine learning algorithm may receive a plurality of image frames featuring a person, and output a gait representation that indicates how the person moves. Person classification component 415 may combine the outputs from the machine learning algorithms and encode the combined output into a single vector format of the signature. In some aspects, cach signature may be a vector of a given length (e.g., 512 bit vector).

It should be noted that even if the person classification component 415 does not filter out PII-related visuals from the extracted images of each person in image 102. person classification component 415 still does not store PII information in its signature. For example, one would still be unable to reverse engineer the signature into PII (such as facial information) because the PII is either directly or indirectly filtered out.

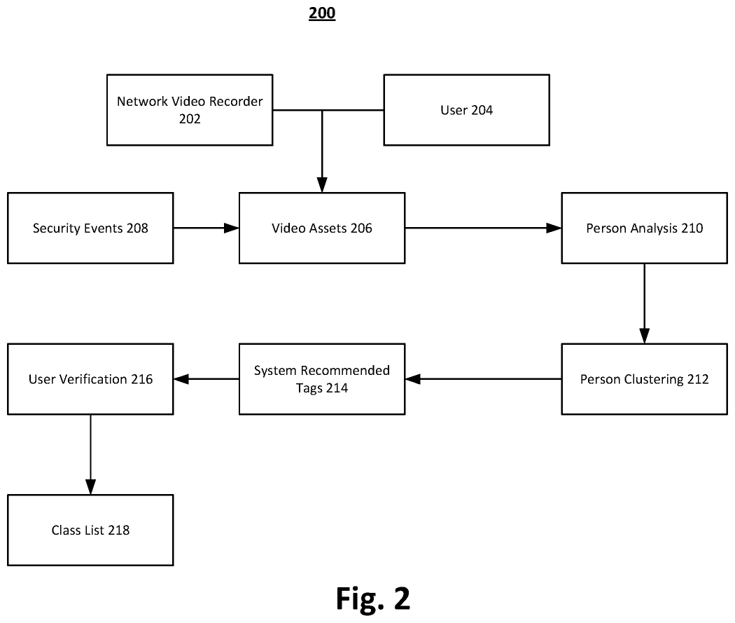

FIG. 2 is block diagram 200 of class generation, which may be performed at least in part by person classification component 415, in accordance with exemplary aspects of the present disclosure. Diagram 200 features network video recorder 202 and user 204, which may provide videos of a monitored environment. Security events 208 may be a component that detects events (e.g., an alarm, a theft, vandalism, aggression, etc.) and stores them in table with timestamps. The person classification component 415 may receive the videos from recorder 202 and/or user 204 and retrieve the clips associated with the events identified by security events 208. For example, the person classification component 415 may extract a video clip of a person running out of a store with a stolen product from the videos provided by user 204 by correlating the time in the video with the timestamps of security events 208.

The person classification component 415 may then identify a person in the video clip and generate a signature as part of person analysis 210. In some aspects, the person classification component 415 may execute a machine learning algorithm that performs clustering (i.e., person clustering 212). The clustering algorithm may receive the signature, the timestamp of the corresponding security event, an alarm identifier, a product identifier, and a product price. Because there may be several security events of a given type (e.g., a theft, vandalism, etc.) clustering enables a user (e.g., security personnel) to analyze how a person causes a security event. For example, products of a certain type (e.g., electronics) or a certain price range may be more likely to be stolen. In several cases, a red shopper performs a theft in a first store and immediately performs another theft of the same product in another store. By clustering, the likelihood of identifying the person is increased because the behavior (e.g., time of day, product preference, etc.) are taken into consideration in the absence of PII.

The person classification component 415 may group clusters by numbers of alarms and cost of product and recommend a tag for each person. For example, a first tag may label a first person as a thief, a second tag may label a second person as a customer, and a third tag may label a third person as an employee.

In some aspects, the person classification component 415 may present these tags to the user (e.g., a store manager) that manually verifies the recommended tags. Upon approval (i.e., user verification 216), the person classification component 415 generates class list 218, which lists cach known signature and the associated tag.

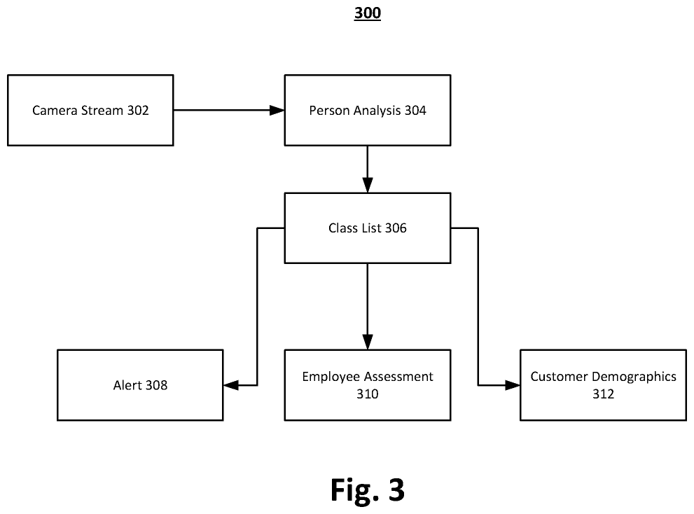

In some aspects, FIG. 3 is block diagram 300 of performing actions based on a detected class of a person, which may be performed at least in part by person classification component 415, in accordance with exemplary aspects of the present disclosure.

While diagram 200 depicts how the person classification component 415 creates class list 218 of labelled signatures, diagram 300 utilizes class list 218 (relabeled as class list 306) to determine whether any arbitrary person is a security risk, an employee, or a customer. Accordingly, the person classification component 415 receives camera stream 302, performs person analysis 304 (e.g., generates a signature), compares the signature against class list 306, and performs an action based on the class. For example, if a red shopper is detected, the person classification component 415 may generate alert 308. If a staff member is detected, the person classification component 415 may execute employee assessment 310 (e.g., store movement information). If a customer is detected the person classification component 415 may store customer demographics 312 (e.g., age, gender, visit frequency, conversion rate, customer profile, etc.). This information may be used for marketing.

In some aspects, the person classification component 415 may store class list 306 in a central repository accessible by other users. Because stores often experience repeat offenders (e.g., a red shopper robbing several department stores of the same chain), by sharing the signature of a known red shopper, other users can immediately protect themselves. Using the central repository, multiple user data can be used to identify trends and paths.

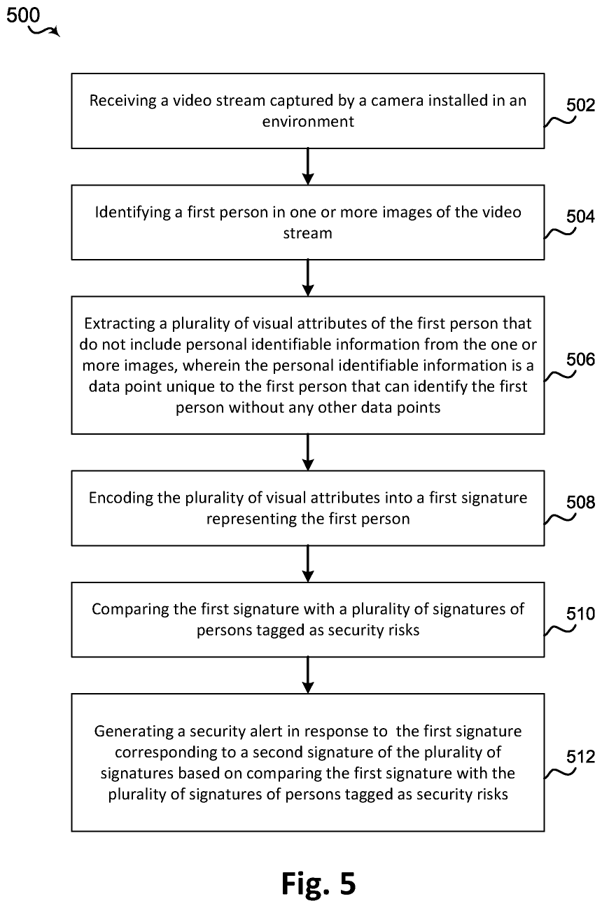

Referring to FIG. 4 and FIG. 5, in operation, computing device 400 may perform a method 500 for person detection in a security system, by such as via execution of person classification component 415 by processor 405 and/or memory 410.

At block 502, the method 500 includes receiving a video stream captured by a camera installed in an environment. For example, in an aspect, computing device 400, processor 405, memory 410, person classification component 415, and/or receiving component 420 may be configured to or may comprise means for receiving a video stream captured by a camera installed in an environment.

For example, person classification component 415 may receive security footage from one or more security cameras installed in a department store (e.g., Walmart™).

At block 504, the method 500 includes identifying a first person in one or more images of the video stream. For example, in an aspect, computing device 400, processor 405, memory 410, person classification component 415, and/or identifying component 425 may be configured to or may comprise means for identifying a first person (e.g., person 104) in one or more images (e.g., image 102) of the video stream.

For example, the identifying at block 504 may include executing computer vision algorithms (e.g., keypoint detection, edge detection, etc.) and/or machine learning algorithms (e.g., person detection) to determine that image 102 includes a group of pixels that depict a human. In some aspects, identifying the first person further comprises generating a boundary (e.g., a rectangle) around the group of pixels depicting the first person, and extracting the group of pixels within the boundary (e.g., by cropping) for further analysis.

At block 506, the method 500 includes extracting a plurality of visual attributes of the first person that do not include personal identifiable information from the one or more images, wherein the personal identifiable information is a data point unique to the first person that can identify the first person without any other data points. For example, in an aspect, computing device 400, processor 405, memory 410, person classification component 415, and/or extracting component 430 may be configured to or may comprise means for extracting a plurality of visual attributes of the first person that do not include personal identifiable information from the one or more images, wherein the personal identifiable information is a data point unique to the first person that can identify the first person without any other data points.

For example, the extracting at block 506 may include extracting visual attributes such as attire information (e.g., colors, patterns, and sizes of tops, bottoms, hoodies, shoes, headwear, outerwear), gender (e.g., male, female, etc.), ethnicity, age group, and gait analysis information (e.g., posture, movement, walking style, etc.). It should be noted that the visual attributes do not include personal identifiable information such as facial features, biometrics (e.g., retina scans, fingerprints, etc.), identification card information, etc., that can be used without any other data to still identify the first person. By extracting visual attributes that are not PII, the privacy of the person remains intact, which is especially important in the majority of cases where a person is a non-malicious entity such as a customer.

At block 508, the method 500 includes encoding the plurality of visual attributes into a first signature representing the first person. For example, in an aspect, computing device 400, processor 405, memory 410, person classification component 415, and/or encoding component 435 (which may include autoencoder 117) may be configured to or may comprise means for encoding the plurality of visual attributes into a first signature representing the first person.

For example, the encoding at block 508 may include inputting the group of pixels within the boundary described above into autoencoder 117, which outputs the first signature. In some aspects, the visual attributes may be input into autoencoder 117 as a secondary vector. Thus, the signature includes the visual information from the group of pixels and the specific visual attributes. In other aspects, the visual attributes are input into autoencoder 117 as the sole vector. For example, the vector may be structured as <red shirt, blue jeans, black cap, male, Caucasian, 44, limp>. The signature of this vector may be a collection of numbers and characters that are an abstract representation of the vector.

At block 510, the method 500 includes comparing the first signature with a plurality of signatures of persons tagged as security risks. For example, in an aspect, computing device 400, processor 405, memory 410, person classification component 415, and/or comparing component 440 may be configured to or may comprise means for comparing the first signature with a plurality of signatures of persons tagged as security risks.

For example, the comparing at block 510 may include comparing the first signature against at least one signature in a database storing signatures of security risk-related persons.

At block 512, the method 500 includes generating a security alert in response to the first signature corresponding to a second signature of the plurality of signatures based on comparing the first signature with the plurality of signatures of persons tagged as security risks. For example, in an aspect, computing device 400, processor 405, memory 410, person classification component 415, and/or generating component 445 may be configured to or may comprise means for generating a security alert in response to the first signature corresponding to a second signature of the plurality of signatures based on comparing the first signature with the plurality of signatures of persons tagged as security risks.

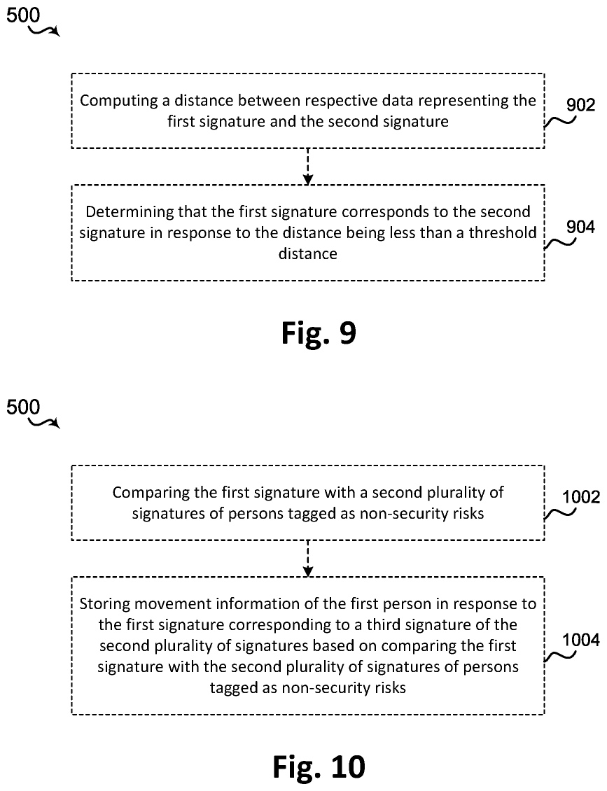

For example, the generating at block 512 may include calculating a distance between the first signature and the second signature. Because the distance calculation of vectors suggests that a low distance means the vectors are close, person classification component 415 may determine a correspondence between signatures when the distance is less than a threshold distance. This is further described in FIG. 9.

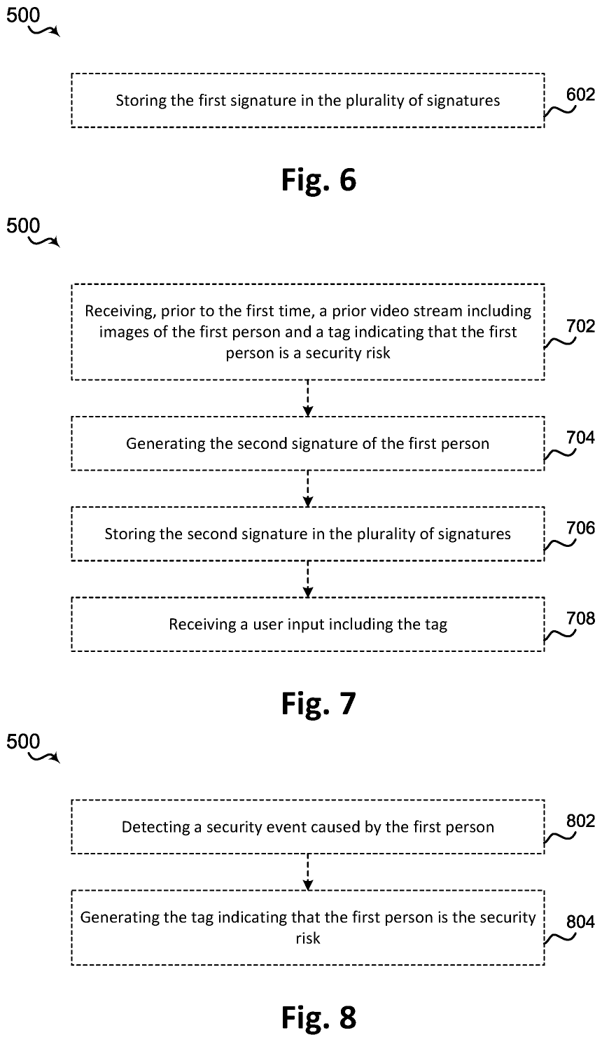

Referring to FIG. 6, in an alternative or additional aspect, at block 602, the method 500 may further include storing the first signature in the plurality of signatures. For example, in an aspect, computing device 400, processor 405, memory 410, person classification component 415, and/or storing component 450 may be configured to or may comprise means for storing the first signature in the plurality of signatures. When a person is classified as a security risk (i.e., a red shopper), their signature may be stored in the database of security risk signatures.

Referring to FIG. 7, in an alternative or additional aspect wherein the video stream is received at a first time, at block 702, the method 500 may further include receiving, prior to the first time, a prior video stream including images of the first person and a tag indicating that the first person is a security risk. For example, in an aspect, computing device 400, processor 405, memory 410, person classification component 415, and/or receiving component 420 may be configured to or may comprise means for receiving, prior to the first time, a prior video stream including images of the first person and a tag indicating that the first person is a security risk. FIG. 7 describes how an entry in the database storing signatures of security-risk persons is generated. At block 702, a user or security system may provide a video of the first person and manually tag him/her as a security risk.

In this optional aspect, at block 704, the method 500 may further include generating the second signature of the first person. For example, in an aspect, computing device 400, processor 405, memory 410, person classification component 415, and/or generating component 445 may be configured to or may comprise means for generating the second signature of the first person. For example, person classification component 415 may input an image of the first person and/or a video of the first person in autoencoder 117, which produces the second signature (used at a later time to re-identify the first person).

In this optional aspect, at block 706, the method 500 may further include storing the second signature in the plurality of signatures. For example, in an aspect, computing device 400, processor 405, memory 410, person classification component 415, and/or storing component 450 may be configured to or may comprise means for storing the second signature in the plurality of signatures.

In this optional aspect, at block 708, the method 500 may further include receiving a user input including the tag. For example, in an aspect, computing device 400, processor 405, memory 410, person classification component 415, and/or receiving component 450 may be configured to or may comprise means for receiving a user input including the tag. For example, the user input may be a command on a computer system.

Referring to FIG. 8, in an alternative or additional aspect, at block 802, the method 500 may further include detecting a security event caused by the first person. For example, in an aspect, computing device 400, processor 405, memory 410, person classification component 415, and/or detecting component 455 may be configured to or may comprise means for detecting a security event caused by the first person.

For example, the detecting at block 802 may include determining that the first person performed a theft or vandalism. The security event may be loss of a product, the theft, or damages in the environment.

In this optional aspect, at block 804, the method 500 may further include generating the tag indicating that the first person is the security risk. For example, in an aspect, computing device 400, processor 405, memory 410, person classification component 415, and/or generating component 445 may be configured to or may comprise means for generating the tag indicating that the first person is the security risk. In this case, person classification component 415 maps the security event to the first person. Because the first person is the cause of the security event (e.g., the first person may be holding the item that was stolen, or may be seen running from the environment suspiciously), person classification component 415 automatically tags the first person as a security risk.

Referring to FIG. 9, in an alternative or additional aspect, at block 902, the method 500 may further include computing a distance between respective data representing the first signature and the second signature. For example, in an aspect, computing device 400, processor 405, memory 410, person classification component 415, and/or computing component 460 may be configured to or may comprise means for computing a distance between respective data representing the first signature and the second signature. For example, the distance between signature u and signature v is d(u, v)=∥u−v∥=√((u₁−v₁)²+(u₂−v₂)²+ . . . (uₙ−vₙ)²).

In this optional aspect, at block 904, the method 500 may further include determining that the first signature corresponds to the second signature in response to the distance being less than a threshold distance. For example, in an aspect, computing device 400, processor 405, memory 410, person classification component 415, and/or determining component 465 may be configured to or may comprise means for determining that the first signature corresponds to the second signature in response to the distance being less than a threshold distance.

In an alternative or additional aspect, the environment is a retail environment and the first person is tagged for theft, wherein the second signature is associated with an identifier of a product that was stolen and the first signature is associated with the identifier of the product. For example, the distance will be lower if the first signature and the second signature both feature a similar person holding the same product.

In an alternative or additional aspect, the environment is a retail environment and the first person is tagged for theft, wherein the second signature is associated with a location, in the retail environment, where a product was stolen and the first signature is associated with the location where the first person is standing. For example, the distance will be lower if the first signature and the second signature both feature a similar person in the same location where a theft occurred.

Referring to FIG. 10, in an alternative or additional aspect, at block 1002, the method 500 may further include comparing the first signature with a second plurality of signatures of persons tagged as non-security risks. For example, in an aspect, computing device 400, processor 405, memory 410, person classification component 415, and/or comparing component 440 may be configured to or may comprise means for comparing the first signature with a second plurality of signatures of persons tagged as non-security risks. For example, the comparison of signatures may be used to identify employees and customers in a retail environment. It is not necessary for the database to solely include security risk individuals.

In this optional aspect, at block 1004, the method 500 may further include storing movement information of the first person in response to the first signature corresponding to a third signature of the second plurality of signatures based on comparing the first signature with the second plurality of signatures of persons tagged as non-security risks. For example, in an aspect, computing device 400, processor 405, memory 410, person classification component 415, and/or storing component 450 may be configured to or may comprise means for storing movement information of the first person in response to the first signature corresponding to a third signature of the second plurality of signatures based on comparing the first signature with the second plurality of signatures of persons tagged as non-security risks.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment. unless stated otherwise.

What is claimed is:

1. An apparatus for person detection in a security system, comprising:
a memory; and
a processor coupled with the memory and configured to:
receive a video stream captured by a camera installed in an environment;
identify a first person in one or more images of the video stream;
extract a plurality of visual attributes of the first person that do not include personal identifiable information from the one or more images, wherein the personal identifiable information is a data point unique to the first person that can identify the first person without any other data points;
encode the plurality of visual attributes into a first signature representing the first person;
compare the first signature with a plurality of signatures of persons tagged as security risks; and
generate a security alert in response to the first signature corresponding to a second signature of the plurality of signatures based on comparing the first signature with the plurality of signatures of persons tagged as security risks.

2. The apparatus of claim 1, wherein the processor is further configured to store the first signature in the plurality of signatures.

3. The apparatus of claim 1, wherein the video stream is received at a first time, wherein the processor is further configured to:
receive, prior to the first time, a prior video stream including images of the first person and a tag indicating that the first person is a security risk;
generate the second signature of the first person; and
store the second signature in the plurality of signatures.

4. The apparatus of claim 3, wherein the processor is further configured to receive a user input including the tag.

5. The apparatus of claim 3, wherein the processor is further configured to:
detect a security event caused by the first person; and
generate the tag indicating that the first person is the security risk.

6. The apparatus of claim 1, wherein the processor is further configured to:
compute a distance between respective data representing the first signature and the second signature; and
determine that the first signature corresponds to the second signature in response to the distance being less than a threshold distance.

7. The apparatus of claim 1, wherein the plurality of visual attributes comprises one or more of: attire, gender, ethnicity, age group, hair color, or gait.

8. The apparatus of claim 1, wherein the environment is a retail environment and the first person is tagged for theft, wherein the second signature is associated with an identifier of a product that was stolen and the first signature is associated with the identifier of the product.

9. The apparatus of claim 1, wherein the environment is a retail environment and the first person is tagged for theft, wherein the second signature is associated with a location, in the retail environment, where a product was stolen and the first signature is associated with the location where the first person is standing.

10. The apparatus of claim 1, wherein the processor is further configured to:
compare the first signature with a second plurality of signatures of persons tagged as non-security risks; and
store movement information of the first person in response to the first signature corresponding to a third signature of the second plurality of signatures based on comparing the first signature with the second plurality of signatures of persons tagged as non-security risks.

11. A method for person detection in a security system, comprising:
receiving a video stream captured by a camera installed in an environment;
identifying a first person in one or more images of the video stream;
extracting a plurality of visual attributes of the first person that do not include personal identifiable information from the one or more images, wherein the personal identifiable information is a data point unique to the first person that can identify the first person without any other data points;
encoding the plurality of visual attributes into a first signature representing the first person;
comparing the first signature with a plurality of signatures of persons tagged as security risks; and
generating a security alert in response to the first signature corresponding to a second signature of the plurality of signatures based on comparing the first signature with the plurality of signatures of persons tagged as security risks.

12. The method of claim 11, further comprising storing the first signature in the plurality of signatures.

13. The method of claim 11, wherein the video stream is received at a first time, further comprising:
receiving, prior to the first time, a prior video stream including images of the first person and a tag indicating that the first person is a security risk;
generating the second signature of the first person; and
storing the second signature in the plurality of signatures.

14. The method of claim 13, further comprising receiving a user input including the tag.

15. The method of claim 13, further comprising:
detecting a security event caused by the first person; and
generating the tag indicating that the first person is the security risk.

16. The method of claim 11, further comprising:
computing a distance between respective data representing the first signature and the second signature; and
determining that the first signature corresponds to the second signature in response to the distance being less than a threshold distance.

17. The method of claim 11, wherein the plurality of visual attributes comprises one or more of: attire, gender, ethnicity, age group, hair color, or gait.

18. The method of claim 11, wherein the environment is a retail environment and the first person is tagged for theft, wherein the second signature is associated with an identifier of a product that was stolen and the first signature is associated with the identifier of the product.

19. The method of claim 11, wherein the environment is a retail environment and the first person is tagged for theft, wherein the second signature is associated with a location, in the retail environment, where a product was stolen and the first signature is associated with the location where the first person is standing.

20. The method of claim 11, further comprising:
comparing the first signature with a second plurality of signatures of persons tagged as non-security risks; and
storing movement information of the first person in response to the first signature corresponding to a third signature of the second plurality of signatures based on comparing the first signature with the second plurality of signatures of persons tagged as non-security risks.
